(19) United States
(12) Patent Application Publication
(10) Pub. No.: US 2020/0087967 A1
(43) Pub. Date: Mar. 19, 2020

(54) VEHICLE INTERIOR COMPONENT

(71) Applicant: Shanghai Yanfeng Jinqiao Automotive Trim Systems Co. Ltd., Novi, MI (US)

(72) Inventor: Thomas Scott Hodgson, Holland, MI (US)

(21) Appl. No.: 16/693,867

(22) Filed: Nov. 25, 2019

Related U.S. Application Data
(63) Continuation of application No. PCT/US18/40325, filed on Jun. 29, 2018.
(60) Provisional application No. 62/529,836, filed on Jul. 7, 2017.

(51) Int. Cl. E05F 3/22; B60R 7/06; E05F 1/10

(52) U.S. Cl. CPC E05F 3/22; B60R 7/06; E05Y 2201/638; E05Y 2900/538; E05F 1/1025

(57) ABSTRACT

A vehicle interior component is disclosed. The component may comprise a base and a door/cover configured to move from a latched position to cover a bin to an open position to uncover the bin through an unlatched position; and a blocking mechanism configured to actuate a keeper/blocker to move in response to a force from a retracted position to an extended position to prevent the door/cover from moving toward the open position. The mechanism may comprise a blocker/keeper to move from a default/retracted position to a blocking/deployed position to prevent the door/cover from moving to the open position (e.g. in response to the external force). The mechanism may comprise an arm configured to rotate in response to the external force against a retaining spring to engage the blocker/keeper. The component may comprise a console; the cover may comprise a door.

### CROSS-REFERENCE TO RELATED APPLICATIONS

The present application is a continuation of International/PCT Patent Application No. PCT/US18/40325 titled “VEHICLE INTERIOR COMPONENT” filed Jun. 29, 2018, which claims the benefit of U.S. Provisional Patent Application No. 62/529,836 titled “CONSOLE ASSEMBLY FOR VEHICLE INTERIOR” filed Jul. 7, 2017.

The present application claims priority to and incorporates by reference in full the following patent applications: (a) U.S. Provisional Patent Application No. 62/529,836 titled “CONSOLE ASSEMBLY FOR VEHICLE INTERIOR” filed Jul. 7, 2017; (b) International/PCT Patent Application No. PCT/US18/40325 titled “VEHICLE INTERIOR COMPONENT” filed Jun. 29, 2018.

### FIELD

The present invention relates to a vehicle interior component.

### BACKGROUND

It is known to provide in a vehicle interior a component comprising a base with a compartment and a cover movable relative to the base to facilitate access to the compartment.

It would be advantageous to provide an improved vehicle interior component configured for improved functionality and operation comprising features (and combinations of features) as shown and described in the present application including a blocking mechanism for the cover.

### SUMMARY

The present invention relates to a component for a vehicle interior configured for use in a vehicle subjected in operation to at least one external force such as an applied force comprising: a base comprising a bin; a cover configured to move from (a) a latched position to cover the bin to (b) an open position to uncover the bin; and a mechanism configured to move to an extended position to prevent the cover from moving toward the open position in response to an inertial force exceeding a predetermined amount. The cover may comprise an external surface facing the interior of the vehicle; the mechanism may be configured to provide a force to the external surface of the cover to prevent the cover from moving toward the open position. The mechanism may comprise a blocker configured to move from a default position to a blocking position to prevent the cover from moving toward the open position in response to an inertial force on the blocker. The blocker may be configured to provide a force to the external surface of the cover to prevent the cover from moving toward the open position. The blocker may be configured to move from the blocking position to the default position in response to an applied force substantially along the external surface of the cover. The mechanism may comprise a cantilever spring configured to bias the blocker in the blocking position. The cover may be configured to secure the blocker against the base when the blocker is in the blocking position. The cover may be configured to move toward the open position in response to movement of the blocker from the blocking position to the default position. The component may further comprise a spring configured to move the cover toward the open position; the spring may be configured to secure the blocker against the base when the blocker is in the blocking position. The mechanism may comprise an arm configured to move from a biased position to a rotated position to prevent the cover from moving toward the open position; the mechanism may comprise a spring configured to bias the arm in the biased position. The component may further comprise an opening mechanism; the cover may be configured for movement in a first sequence from the latched position to cover the bin to an unlatched position to the open position to uncover the bin; the cover may be configured for movement in a second sequence from the latched position to the unlatched position to a blocked position covering the bin to the open position; the opening mechanism may be configured to move the cover from the unlatched position to the open position; from the unlatched position to the blocked position and from the blocked position to the open position; the mechanism may be configured to hold the cover in the blocked position. The component may comprise at least one of (a) a console; (b) a console assembly; (c) a floor console; (d) a center console; (e) a storage compartment.

The present invention relates to a component for a vehicle interior configured for use in a vehicle subjected in operation to at least one external force such as an applied force comprising: a base comprising a bin; a cover configured to move from (a) a latched position to cover the bin to (b) an open position to uncover the bin; and a mechanism configured to move to an extended position to prevent the cover from moving toward the open position in response to an inertial force exceeding a predetermined amount. The cover may be configured for a latched state and an unlatched state; the cover may be configured for movement between (a) the latched position with the cover in the latched state; and (b) a blocked position between the latched position and the open position with the cover retained by the mechanism in the unlatched state. The component may comprise an opening mechanism configured to move the cover (a) from an unlatched position to the open position, (b) from the unlatched position to the blocked position and (c) from the blocked position to the open position. The mechanism may comprise a blocker configured to move from a retracted position to an extended position to hold the cover in the blocked position; the blocker may be configured to move from the extended position to the retracted position in response to applied force to allow the cover to move from the blocked position toward the open position. The component may comprise an arm configured to move relative to the blocker in response to an applied force exceeding a predetermined amount to allow the blocker to move from the retracted position to the extended position.

The present invention relates to a component for a vehicle interior configured for use in a vehicle subjected in operation to at least one external force such as an applied force comprising: a base comprising a bin; a cover configured to move from (a) a latched position to cover the bin to (b) an open position to uncover the bin; and a mechanism configured to move to an extended position to prevent the cover from moving toward the open position in response to an inertial force exceeding a predetermined amount. The mechanism may comprise (a) a keeper configured to retain the cover in a blocked position; and (b) an arm configured to actuate the keeper when the inertial force exceeds the predetermined amount. The keeper may comprise a blocker and the blocked position may comprise the closed position. The keeper may be configured to move from a retracted position to a deployed position in which the door is retained in the blocked position. The arm may comprise a mass and may be configured to actuate the keeper when the applied force is greater than the predetermined value. The arm may be configured to be retained by a spring in a position to prevent the keeper from retaining the door in the blocked position; the arm may be configured to move to a position so that the keeper can be deployed to the blocked position when the applied force is greater than the predetermined value; the keeper may be configured to move under actuation from the spring to block movement of the door when the applied force is greater than the predetermined value.

The present invention relates to a component for a vehicle interior configured for use in a vehicle subjected in operation to at least one external force such as an applied force comprising: (a) a base comprising a bin; (b) a cover configured to move from a latched position to cover the bin to an open position to uncover the bin through an unlatched position; and a mechanism configured to move from a retracted position to an extended position to prevent the cover from moving from the unlatched position toward the open position. The mechanism may be configured to move from the retracted position to the extended position in response to the applied force exceeding a predetermined amount. The mechanism may comprise a blocker configured to move from a default position to a blocking position to prevent the cover from moving from the unlatched position to the open position. The blocker may be configured to move from the blocking position to the default position in response to an external force on the blocker. The cover may comprise an external surface facing the interior of the vehicle. The blocker may be configured to provide a force to the external surface of the cover to prevent the cover from moving from the unlatched position toward the open position. The blocker may be configured to move from the blocking position to the default position in response to the applied force substantially along the external surface of the cover. The mechanism may comprise an arm configured to move from a biased position to a rotated position to prevent the cover from moving from the unlatched position to the open position. The mechanism may comprise a first spring configured to bias the arm in the biased position. The arm may be configured to move relative to the blocker in response to a force exceeding a predetermined amount to allow the blocker to move from the default position to the blocking position. The mechanism may comprise a second spring configured to bias the blocker in the blocking position. The second spring may be configured to move the blocker from the default position to the blocking position to prevent the cover from moving from the unlatched position to the open position. The second spring may comprise a cantilever spring. The mechanism may be configured to hold the cover in a blocked position in response to the applied force exceeding a predetermined amount. The cover may be configured to secure the blocker against the base when the cover is in the blocked position. The cover may be configured to move from the blocked position to the open position in response to movement of the blocker from the blocking position to the default position. The component may comprise a spring configured to move the cover from the unlatched position to the open position and configured to secure the blocker against the base when the cover is in the blocked position. The applied force may comprise an inertial force.

The present invention also relates to a component for a vehicle interior configured for use in a vehicle subjected in operation to at least one external force such as an applied force comprising a base comprising a bin; and a cover configured for movement in a first sequence from (a) a latched position to cover the bin to (b) an open position to uncover the bin. The cover may be configured for movement in a second sequence from (1) the latched position to (2) a blocked position covering the bin to (3) the open position. The component may comprise an opening mechanism configured to move the cover (a) from an unlatched position to the open position, (b) from the unlatched position to the blocked position and (c) from the blocked position to the open position. The component may comprise a blocker configured to hold the cover in the blocked position. The blocker may be configured to move from a retracted position to an extended position to prevent the cover from moving from the unlatched position toward the open position. The blocker may be configured to move from the extended position to the retracted position in response to an external force to allow the cover to move from the blocked position toward the open position. The component may comprise an arm configured to move relative to the blocker in response to the applied force exceeding a predetermined amount to allow the blocker to move from the retracted position to the extended position.

The present invention related to a component for a vehicle interior configured for use in a vehicle subjected in operation to at least one external force such as an applied force. The component may comprise a base comprising a compartment configured to be accessed through an opening and a door configured for movement from a closed position to cover the opening of the compartment to an open position to uncover the opening of the compartment; the component may comprise a mechanism configured to be actuated by the applied force and configured to retain the door in the closed position when the applied force is greater than a predetermined value. The mechanism may comprise an arm configured to be actuated by the applied force, a keeper configured to retain the door in a blocked position and a spring configured to engage the keeper. The component may comprise an opening mechanism configured to move the door from an unlatched position to the open position, from the unlatched position to the blocked position and from the blocked position to the open position. The component may comprise a blocker; the blocked position may comprise the closed position.

The keeper may be configured to move from a retracted position to a deployed position in which the door is retained in the blocked position. The arm may comprise a mass and may be configured to actuate the keeper to the blocked position when the applied force is greater than the predetermined value. The arm may be configured to be retained by a spring in a position to prevent the keeper from retaining the door in the blocked position; and the arm may be configured to move to a position so that the keeper can be deployed to the blocked position when the applied force is greater than the predetermined value. The keeper may be configured to move under actuation from the spring to block movement of the door when the applied force is greater than the predetermined value.

### FIGURES

FIG. 1A is a schematic perspective view of a vehicle according to an exemplary embodiment.

FIG. 1B is a schematic perspective view of a vehicle showing a vehicle interior according to an exemplary embodiment.

FIGS. 1C through 1D are schematic perspective views of a vehicle interior component shown as a console assembly according to an exemplary embodiment.

FIGS. 2A through 2D are schematic perspective views of a vehicle interior component shown as a console assembly according to an exemplary embodiment.

FIG. 3A is a schematic perspective view of a vehicle interior component shown as a console assembly according to an exemplary embodiment.

FIGS. 3B through 3E are schematic side views of the operation of a vehicle interior component shown as a console assembly according to an exemplary embodiment.

FIGS. 4A through 4D are schematic perspective views of a vehicle interior component shown as a console assembly according to an exemplary embodiment.

FIG. 5A is a schematic exploded perspective view of a vehicle interior component shown as a console assembly according to an exemplary embodiment.

FIG. 5B is a schematic exploded perspective view of a mechanism of a vehicle interior component shown as a console assembly according to an exemplary embodiment.

FIG. 5C is a schematic perspective view of a vehicle interior component shown as a console assembly according to an exemplary embodiment.

FIG. 5D is a schematic fragmentary perspective view of a blocker of a vehicle interior component shown as a console assembly according to an exemplary embodiment.

FIG. 6A is a schematic perspective view of a vehicle interior component shown as a console assembly according to an exemplary embodiment.

FIG. 6B is a schematic fragmentary perspective view of a vehicle interior component shown as a console assembly according to an exemplary embodiment.

FIG. 6C is a schematic perspective view of a vehicle interior component shown as a console assembly according to an exemplary embodiment.

FIG. 6D is a schematic fragmentary perspective view of a vehicle interior component shown as a console assembly according to an exemplary embodiment.

FIG. 6E is a schematic perspective view of a vehicle interior component shown as a console assembly according to an exemplary embodiment.

FIG. 6F is a schematic fragmentary perspective view of a vehicle interior component shown as a console assembly according to an exemplary embodiment.

FIG. 7A is a schematic fragmentary section view of a vehicle interior component shown as a console assembly according to an exemplary embodiment.

FIG. 7B is a schematic fragmentary side view of a vehicle interior component shown as a console assembly according to an exemplary embodiment.

FIG. 7C is a schematic fragmentary section view of a vehicle interior component shown as a console assembly according to an exemplary embodiment.

FIG. 7D is a schematic fragmentary side view of a vehicle interior component shown as a console assembly according to an exemplary embodiment.

FIG. 7E is a schematic fragmentary section view of a vehicle interior component shown as a console assembly according to an exemplary embodiment.

FIG. 7F is a schematic fragmentary side view of a vehicle interior component shown as a console assembly according to an exemplary embodiment.

FIG. 8A is a schematic fragmentary section view of a vehicle interior component shown as a console assembly according to an exemplary embodiment.

FIG. 8B is a schematic fragmentary side view of a vehicle interior component shown as a console assembly according to an exemplary embodiment.

FIG. 8C is a schematic fragmentary section view of a vehicle interior component shown as a console assembly according to an exemplary embodiment.

FIG. 8D is a schematic fragmentary side view of a vehicle interior component shown as a console assembly according to an exemplary embodiment.

FIG. 8E is a schematic fragmentary section view of a vehicle interior component shown as a console assembly according to an exemplary embodiment.

FIG. 8F is a schematic fragmentary side view of a vehicle interior component shown as a console assembly according to an exemplary embodiment.

### DESCRIPTION

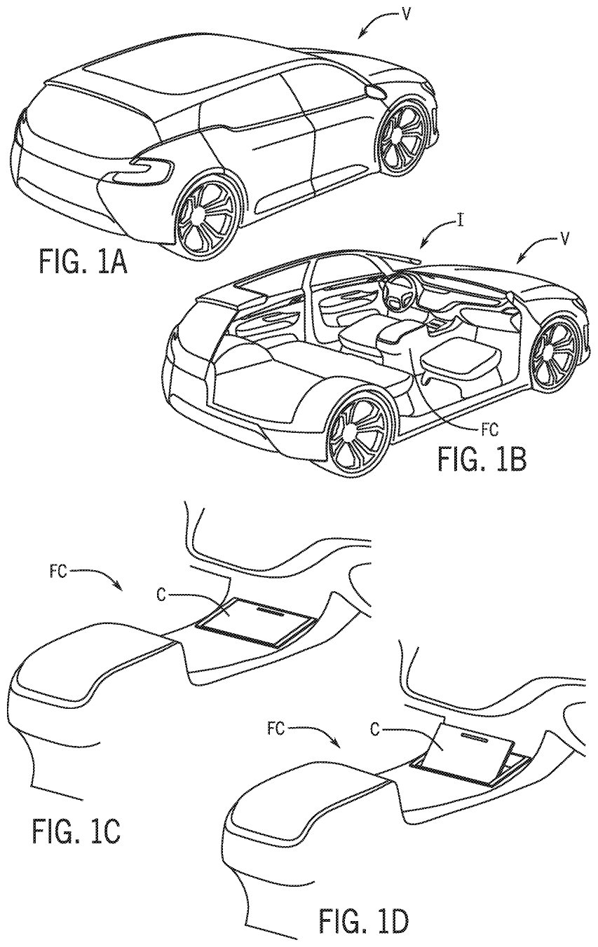

According to an exemplary embodiment as shown schematically in FIGS. 1A through 1D, a vehicle V is shown including an interior I with a vehicle interior component shown as floor console FC. Floor console FC may comprise a base with a compartment or bin shown as a storage compartment with an opening and a door configured to be (or provide) a cover C for the compartment. The door or cover C may be configured to move between a closed position and an open position to facilitate access (through the opening) to the storage compartment.

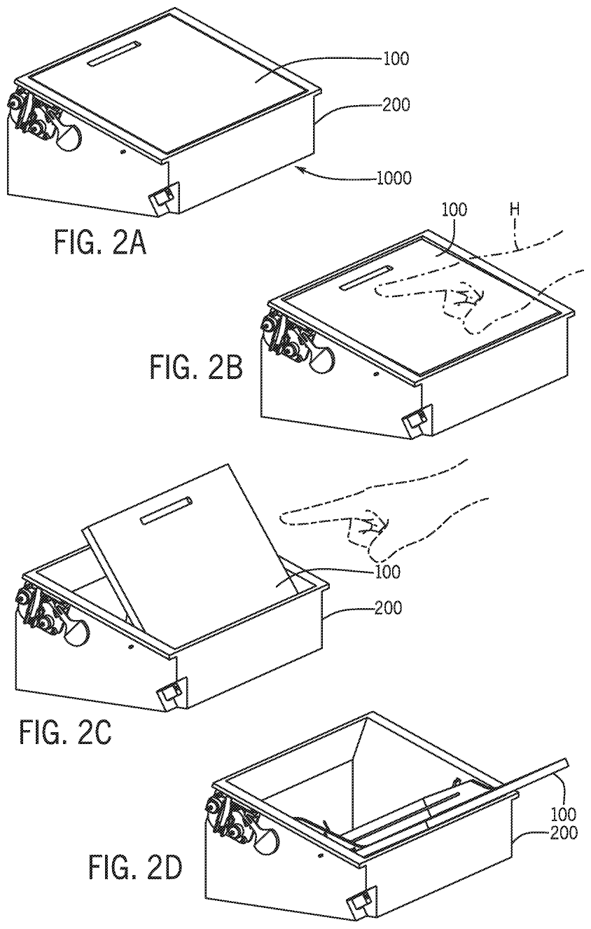

According to an exemplary embodiment as shown schematically in FIGS. 2A through 2D, a vehicle interior component 1000 shown as a console may comprise a cover 100 and a base 200. Cover 100 may be coupled to base 200 and may be configured for movement between a closed position and an open position in response to an external force. According to an exemplary embodiment, base 200 may comprise a storage compartment and cover 100 may be configured to cover the storage compartment in the closed position and uncover the storage compartment in the open position.

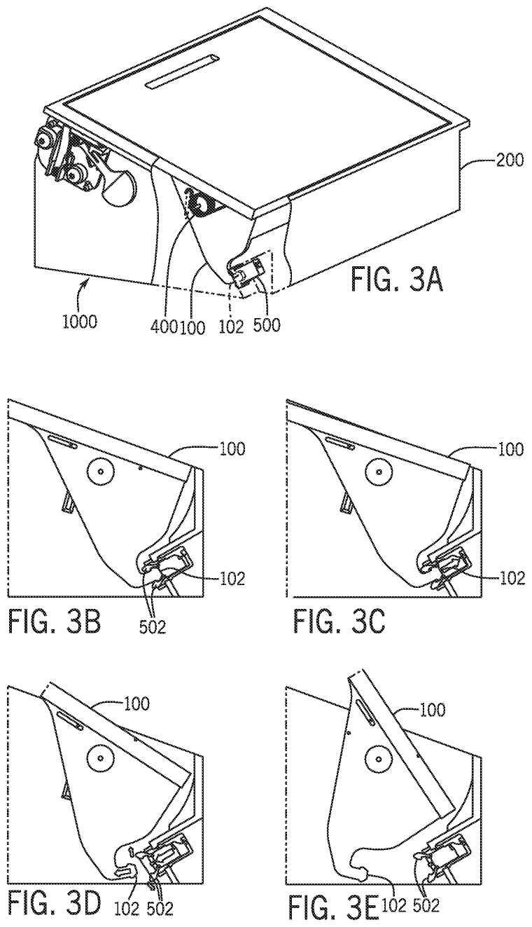

According to an exemplary embodiment as shown schematically in FIGS. 3A through 3E, cover 100 may comprise a plunger 102 and base 200 may comprise a catch 500 and a spring 400. Catch 500 may comprise a set of arms 502. Plunger 102 may engage with catch 500 to retain cover 100 in the closed position as shown schematically in FIGS. 3A and 3B. By application of an external force, cover 100 may be rotated/pushed (e.g. downward) toward an unlatched position and set of arms 502 of catch 500 may move away from plunger 102; plunger 102 may disengage from set of arms 502 of catch 500 and spring 400 may provide a force to move cover 100 from the unlatched position toward an open position. (See FIGS. 3C through 3E.)

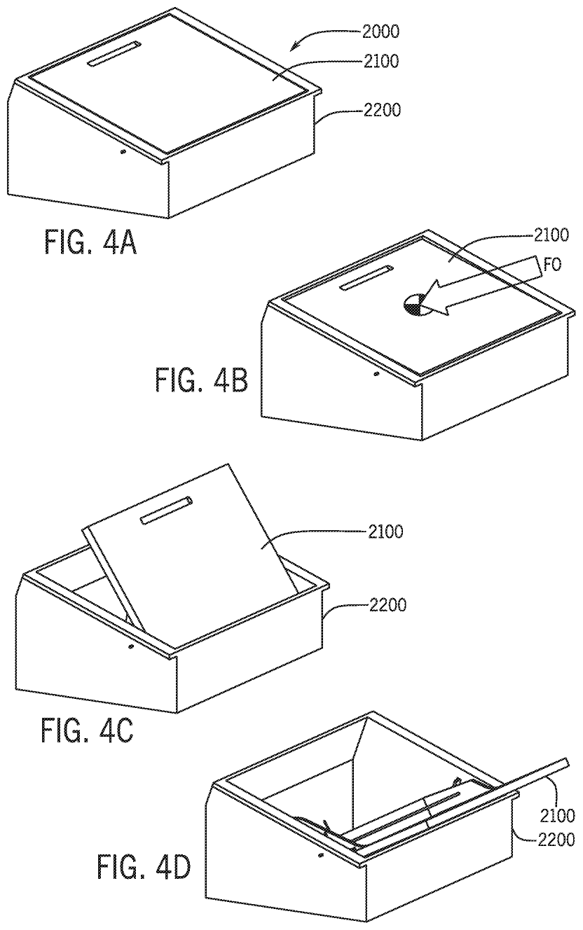

According to an exemplary embodiment as shown schematically in FIGS. 4A through 4D, a conventional vehicle interior component 2000 shown as a console may comprise a cover 2100 and a base 2200. Cover 2100 may be coupled to base 2200 and may be configured for movement between a closed position and an open position in response to an external force. According to an exemplary embodiment, base 2200 may comprise a storage compartment and cover 2100 may be configured to cover the storage compartment in the closed position and uncover the storage compartment in the open position. By application of an external force FO acting against the center of gravity of cover 2100, cover 2100 is rotated (e.g. downward) toward an unlatched position and a conventional spring provides a force to move cover 2100 from the unlatched position toward an open position.

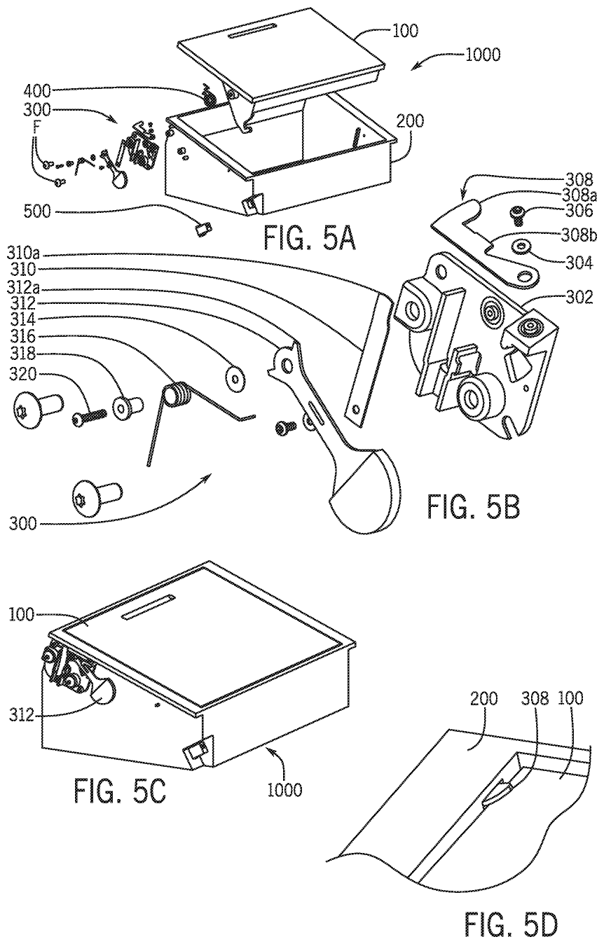

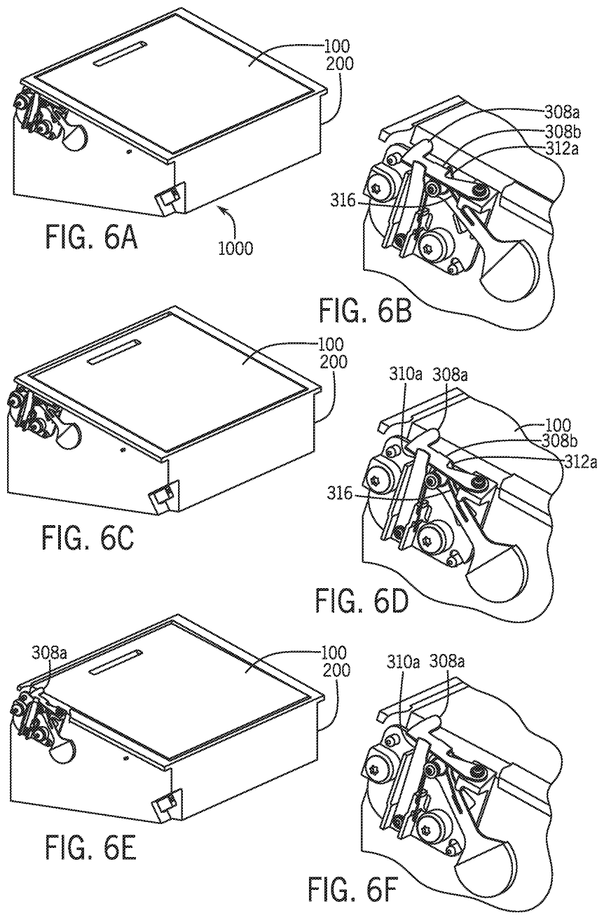

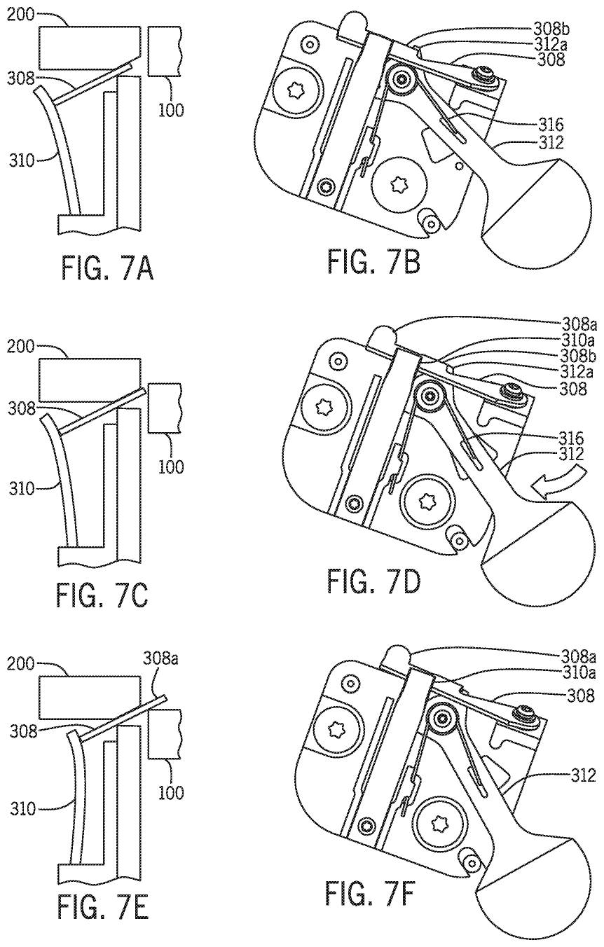

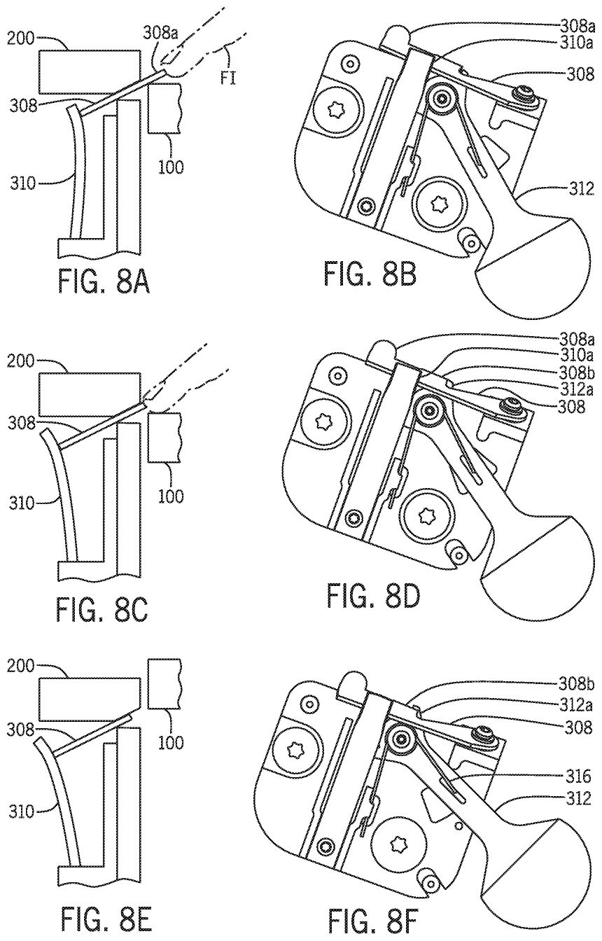

According to an exemplary embodiment as shown schematically in FIGS. 3A through 3E, 5A through 5D, 6A through 6F, 7A through 7F and 8A through 8F, a component for a vehicle interior 1000 may comprise a base 200 comprising a bin, a cover 100 configured to move from a latched position (see FIGS. 3A, 3B, 5C, 6A, 6B, 7A and 7B) to cover the bin to an open position (see FIG. 3E) to uncover the bin through an unlatched position (see FIGS. 3D, 6C, 6D, 7C and 7D); and a mechanism shown as a blocking mechanism 300 configured to move from a retracted position (see FIGS. 3A through 3E, 5C, 6A, 6B, 7A and 7B) to an extended position (see FIGS. 5D, 6E, 6F, 7E, 7F, 8A and 8B) to prevent cover 100 from moving from the unlatched position toward the open position. Blocking mechanism 300 may be configured to move from the retracted position to the extended position in response to a force exceeding a predetermined amount. Mechanism 300 may comprise a member shown as a keeper or blocker 308 configured to move from a default position (see FIGS. 3A through 3E, 5C, 6A, 6B, 7A and 7B) to a blocking position (see FIGS. 5D, 6E, 6F, 7E, 7F, 8A and 8B) to prevent cover 100 from moving from the unlatched position to the open position. Blocker/keeper 308 may be configured to move from the blocking position to the default position in response to an external force on blocker/keeper 308. Cover 100 may comprise an external surface facing the interior of the vehicle. Blocker 308 may be configured to provide a force to the external surface of cover 100 to prevent cover 100 from moving from the unlatched position toward the open position (see FIGS. 5D, 6E, 6F, 7E, 7F, 8A and 8B). Blocker 308 may be configured to move from the blocking position to the default position in response to an external force substantially along the external surface of cover 100. Mechanism 300 may comprise an arm 312 configured to move from a biased position (see FIGS. 3A through 3E, 5C, 6A, 6B, 7A and 7B) to a rotated position (see FIGS. 6E, 6F, 7F and 8B) to prevent the cover from moving from the unlatched position to the open position. Mechanism 300 may comprise a first spring 316 configured to bias arm 312 in the biased position (see FIGS. 6A, 6B and 7B). Arm 312 may be configured to move relative to blocker 308 in response to a force exceeding a predetermined amount to allow blocker 308 to move from the default position to the blocking position (see FIGS. 7B, 7D and 7F). Mechanism 300 may comprise a second spring shown as flat spring 310 configured to bias blocker 308 in the blocking position (see FIGS. 6E, 6F, 7E, 7F, 8A and 8B). Second spring 310 may be configured to move blocker 308 from the default position to the blocking position to prevent cover 100 from moving from the unlatched position to the open position (see FIGS. 6A through 6F and 7A through 7F). Second spring 310 may comprise a cantilever spring. Mechanism 300 may be configured to hold cover 100 in a blocked position in response to a force exceeding a predetermined amount (see FIGS. 5D, 6E, 6F, 7E and 7F). Cover 100 may be configured to secure blocker 308 against base 200 when cover 100 is in the blocked position (see FIGS. 5D, 7E and 8A). Cover 100 may be configured to move from the blocked position to the open position in response to movement of the blocker from the blocking position to the default position (see FIGS. 8A through 8F). Component 1000 may comprise a spring or opening mechanism 400 configured to move cover 100 from the unlatched position to the open position and configured to secure blocker 308 against base 200 when cover 100 is in the blocked position (see FIG. 5A). The force may comprise an inertial force.

According to an exemplary embodiment as shown schematically in FIGS. 3A through 3E, 5A through 5D, 6A through 6F, 7A through 7F and 8A through 8F, a component 1000 for a vehicle interior may comprise a base 200 comprising a bin and a cover 100 configured for movement in a first sequence from a latched position (see FIGS. 3A, 3B, 5C, 6A, 6B, 7A and 7B) to cover the bin to an open position (see FIG. 3E) to uncover the bin. Cover 100 may be configured for movement in a second sequence from the latched position to a blocked position (see FIGS. 5D, 6E, 6F, 7E, 7F, 8A and 8B) covering the bin to the open position. Component 1000 may comprise an opening mechanism or spring 400 configured to move the cover (a) from an unlatched position (see FIGS. 3D, 6C, 6D, 7C and 7D) to the open position, (b) from the unlatched position to the blocked position and (c) from the blocked position to the open position. Component 1000 may comprise a blocker 308 configured to hold cover 100 in the blocked position (see FIGS. 5D, 6E, 6F, 7E, 7F, 8A and 8B). Blocker 308 may be configured to move from a retracted position (see FIGS. 3A through 3E, 5C, 6A, 6B, 7A and 7B) to an extended position (see FIGS. 5D, 6E, 6F, 7E, 7F, 8A and 8B) to prevent cover 100 from moving from the unlatched position toward the open position. Blocker 308 may be configured to move from the extended position to the retracted position in response to an external force (see FIGS. 8A through 8F) to allow cover 100 to move from the blocked position toward the open position. Component 1000 may comprise an arm 312 configured to move relative to blocker 308 in response to a force exceeding a predetermined amount to allow blocker 308 to move from the retracted position to the extended position (see FIGS. 7B, 7D and 7F).

According to an exemplary embodiment as shown schematically in FIG. 5A, vehicle interior component 1000 (e.g. console, floor console, center console, storage compartment, etc.) may comprise a cover 100 (e.g. door, shade, blind, etc.), a base 200, a mechanism 300, a spring 400, a catch 500 and a fastener F.

According to an exemplary embodiment as shown schematically in FIG. 5B, mechanism 300 may comprise a mounting structure/plate shown as base plate 302, a washer 304, a screw 306, a blocker or keeper 308, a spring shown as flat spring 310, a member shown as arm 312, a washer 314, a spring shown as torsion spring 316, a bushing 318 and a fastener 320. Blocker/keeper 308 may comprise a tab 308a and a portion 308b. Spring 310 may comprise a portion 310a. Arm 312 may comprise a release or trigger 312a.

According to an exemplary embodiment as shown schematically in FIG. 5C, arm 312 may be in a biased position.

According to an exemplary embodiment as shown schematically in FIG. 5D, arm 312 may be in a rotated position and tab 308a of blocker 308 may be in a blocking position preventing cover 100 from moving from an unlatched position to an open position.

According to an exemplary embodiment as shown schematically in FIGS. 6A, 6B, 7A and 7B, cover 100 may be in a closed position relative to base 200. Blocker 308 may be held in a default position by engagement of trigger 312a of arm 312 with a portion 308b of blocker 308. Arm 312 may be biased in a biased position by spring 316.

According to an exemplary embodiment as shown schematically in FIGS. 6C, 6D, 7C and 7D, cover 100 may be in an unlatched position relative to base 200 in response to an inertial force. The inertial force may overcome the force provided by spring 316 to move arm 312 from the biased position toward a rotated position. Trigger 312a may disengage from portion 308b of blocker 308 and a portion 310a of spring 310 may move tab 308a toward cover 100.

According to an exemplary embodiment as shown schematically in FIGS. 6E, 6F, 7E and 7F, cover 100 may be in a blocked position relative to base 200, arm 312 may be in the rotated position. Portion 310a of spring 310 may bias blocker 308 in a blocking position; tab 308a of blocker 308 may prevent movement of cover 100 from the unlatched position toward an open position. Cover 100 may be configured to secure blocker 208 against base 200 when cover 100 is in the blocked position. Cover 100 may comprise an external surface facing the interior of the vehicle. Blocker 308 may be configured to provide a force to the external surface of cover 100 to prevent cover 100 from moving from the unlatched position toward the open position. Mechanism 300 may be configured to hold cover 100 in the blocked position in response to a force exceeding the predetermined amount. Spring 400 may be configured to secure blocker 308 against base 200 when cover 100 is in the blocked position.

According to an exemplary embodiment as shown schematically in FIGS. 8A and 8B, cover 100 may be in a blocked position relative to base 200, arm 312 may be in the rotated position. Portion 310a of spring 310 may bias blocker 308 in a blocking position; tab 308a of blocker 308 may prevent movement of cover 100 from the unlatched position toward an open position. A finger FI may provide a force acting on blocker 308 against the force applied by spring 310 biasing blocker 308 in the blocking position.

According to an exemplary embodiment as shown schematically in FIGS. 8C and 8D, finger FI may provide a force acting on blocker 308 to (a) overcome the force applied by spring 310, (b) deflect spring 310 and (c) move blocker 308 out of engagement with cover 100.

According to an exemplary embodiment as shown schematically in FIGS. 8E and 8F, blocker 308 may be moved from the blocking position to the default position. Trigger 312a of arm 312 may engage with portion 308b of blocker 308. Cover 100 may move from the blocked position toward the open position by spring 400. Cover 100 may be configured to move from the blocked position to the open position in response to movement of blocker 308 from the blocking position to the default position.

### Operation/Use—Door/Cover and Blocking Mechanism

According to an exemplary embodiment as shown schematically in FIGS. 2A through 2D, 3A through 3E, 5A through 5D, 6A through 6F, 7A through 7F and 8A through 8F, a component 1000 for a vehicle interior configured for use in a vehicle subjected in operation to at least one external force such as an applied force comprising: a base 200 comprising a bin; a cover 100 configured to move from (a) a latched position (see FIGS. 3A, 3B, 5C, 6A, 6B, 7A and 7B) to cover the bin to (b) an open position (see FIG. 3E) to uncover the bin; and a mechanism 300 configured to move to an extended position (see FIGS. 5D, 6E, 6F, 7E, 7F, 8A and 8B) to prevent the cover from moving toward the open position in response to an inertial force exceeding a predetermined amount. The component may further comprise an opening mechanism 400; the cover may be configured for movement in a first sequence from the latched position to cover the bin to an unlatched position (see FIGS. 3D, 6C, 6D, 7C and 7D) to the open position to uncover the bin; the cover may be configured for movement in a second sequence from the latched position to the unlatched position to a blocked position (see FIGS. 5D, 7E and 8A) covering the bin to the open position; the opening mechanism may be configured to move the cover from the unlatched position to the open position; from the unlatched position to the blocked position and from the blocked position to the open position; the mechanism may be configured to hold the cover in the blocked position.

According to an exemplary embodiment as shown schematically in FIGS. 4A-4D, the door/cover 2100 comprises a mass/weight that would tend to retain the door/cover in the closed position relative to base 2000 during ordinary use (see FIG. 4A); application of an external force can be used to move the door/cover to the open position (see FIG. 4D) (e.g. overcoming a latch if present such as shown in FIGS. 3A-3E).

As indicated schematically in FIGS. 4B-4C, the door/cover may in use be subjected to application of an external force shown as force FO; under certain exceptional circumstances in use (e.g. an impact event, sudden changes in acceleration, shifting/overturning of the vehicle, etc.), the external force applied may be sufficient to cause the door/cover to move from the closed position toward the open position (e.g. by application an external force that is greater than a threshold force required to overcome the inertial/mass of the cover/door, etc.).

According to an exemplary embodiment as indicated schematically in FIGS. 5A-5D, the vehicle interior component may be provided with a blocking mechanism configured to retain the door/cover in the closed position notwithstanding the application of an external force (such as force FO shown in FIG. 4B); as indicated schematically in FIGS. 6A-6F and 7A-7F, the blocking mechanism may be configured to actuate/transition from an unblocked state (see FIGS. 6A-6B and 7A-7B) to an blocked state (see FIGS. 6E-6F and 7E-7F) where the door/cover is retained in the closed position in response to application of an external force at the blocking mechanism beyond a pre-determined level.

As shown schematically in FIGS. 5A-5D, the blocking mechanism 300 may comprise a base plate 302 with a mass/weight provided on a member shown as arm 312 coupled to a spring shown as torsion spring 316 (e.g. functioning as a biasing/retaining spring) and mounted for pivoting movement relative to the base plate 302 (e.g. retained in a joint/bearing); the arm 312 engages a member shown as blocker or keeper 308 which is mounted for pivoting movement relative to the base (e.g. retained in a joint/bearing) and configured to engage a spring/member shown as flat spring 310; keeper 308 is configured to move from a retracted state (e.g. unblocked state) to an extended/deployed state (e.g. blocking/blocked state) through an opening/slot in the base and to retain the door/cover in the closed position when in the extended/deployed state (see FIGS. 5D, 6F and 7E-7F).

According to an exemplary embodiment shown schematically in FIGS. 4B, 5D, 6A-6F and 7A-7F, the blocking mechanism can be configured to deploy the keeper 308 to the extended/deployed state upon application of an external force above a predetermined threshold force value; the arm 312 can be configured with a mass/form and with spring 318 to be actuated/moved in response to a force above the threshold force value (e.g. by design parameters including mass/spring/force balance, responsiveness/actuation time, etc. in the configuration/form of the members, springs, bearings, etc.); as indicated schematically, movement of the arm 312 will deploy the keeper 308. As indicated schematically in FIGS. 6A-6B and 7A-7B, the arm 312 is configured to engage and hold flat spring 310 to withdraw from full engagement to retain the keeper 308 in the retracted position (as for conventional use). As indicated schematically in FIGS. 6C-6D and 7C-7D, application of an external force above the threshold value will produce movement of arm 312 will progressively disengage flat spring 310 to allow progressive engagement to actuate keeper 308 toward the extended/deployed position; as indicated schematically in FIGS. 6E-6F and 7E-7F, the application of the force to produce further movement of arm 312 will further disengage flat spring 310 to allow complete engagement to move keeper 308 to the extended/deployed position. As shown in FIGS. 5D and 7E-7F, the blocking mechanism will retain the cover/door in the closed position notwithstanding the application of the external force (that otherwise may tend to open the cover/door as shown schematically in FIGS. 4C-4D).

As indicated schematically in FIGS. 8A-8D, the blocking mechanism can be configured to be reset with keeper 308 returned to the retracted position by application of a manual/external force shown as manually applied force FI; under ordinary conditions of use the keeper 308 is maintained in the retracted position by action of the arm 312 holding flat spring 310 out of complete engagement with keeper 308 (see FIGS. 6A-6B, 7A-7B and 8E-8F). As indicated schematically in FIGS. 5D, 6A-6F and 7A-7F, when the blocking mechanism is unactuated, the cover/door is free to move relative to the base; when the blocking mechanism is actuated, the cover/door may be retained in the closed position relative to the base.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior configured for use in a vehicle subjected in operation to at least one external force such as an applied force comprising:
a base comprising a bin;
a cover configured to move from (a) a latched position to cover the bin to (b) an open position to uncover the bin; and
a mechanism configured to move to an extended position to prevent the cover from moving toward the open position in response to an inertial force exceeding a predetermined amount;
wherein the cover comprises an external surface facing the interior of the vehicle;
wherein the mechanism is configured to provide a force to the external surface of the cover to prevent the cover from moving toward the open position.

2. The component of claim 1 wherein the mechanism comprises a blocker configured to move from a default position to a blocking position to prevent the cover from moving toward the open position in response to an inertial force on the blocker.

3. The component of claim 2 wherein the blocker is configured to provide a force to the external surface of the cover to prevent the cover from moving toward the open position.

4. The component of claim 3 wherein the blocker is configured to move from the blocking position to the default position in response to an applied force substantially along the external surface of the cover.

5. The component of claim 2 wherein the mechanism comprises a cantilever spring configured to bias the blocker in the blocking position.

6. The component of claim 2 wherein the cover is configured to secure the blocker against the base when the blocker is in the blocking position.

7. The component of claim 2 wherein the cover is configured to move toward the open position in response to movement of the blocker from the blocking position to the default position.

8. The component of claim 2 further comprising a spring configured to move the cover toward the open position; wherein the spring is further configured to secure the blocker against the base when the blocker is in the blocking position.

9. The component of claim 1 wherein the mechanism comprises an arm configured to move from a biased position to a rotated position to prevent the cover from moving toward the open position; wherein the mechanism comprises a spring configured to bias the arm in the biased position.

10. The component of claim 1 further comprising an opening mechanism;
wherein the cover is configured for movement in a first sequence from the latched position to cover the bin to an unlatched position to the open position to uncover the bin;
wherein the cover is configured for movement in a second sequence from the latched position to the unlatched position to a blocked position covering the bin to the open position;
wherein the opening mechanism is configured to move the cover from the unlatched position to the open position; from the unlatched position to the blocked position and from the blocked position to the open position;
wherein the mechanism is configured to hold the cover in the blocked position.

11. The component of claim 1 comprising at least one of (a) a console; (b) a console assembly; (c) a floor console; (d) a center console; (e) a storage compartment.

12. A component for a vehicle interior configured for use in a vehicle subjected in operation to at least one external force such as an applied force comprising:
a base comprising a bin;
a cover configured to move from (a) a latched position to cover the bin to (b) an open position to uncover the bin; and
a mechanism configured to move to an extended position to prevent the cover from moving toward the open position in response to an inertial force exceeding a predetermined amount;
wherein the cover is configured for a latched state and an unlatched state;
wherein the cover is configured for movement between (a) the latched position with the cover in the latched state; and (b) a blocked position between the latched position and the open position with the cover retained by the mechanism in the unlatched state.

13. The component of claim 12 comprising an opening mechanism configured to move the cover (a) from an unlatched position to the open position, (b) from the unlatched position to the blocked position and (c) from the blocked position to the open position.

14. The component of claim 12 wherein the mechanism comprises a blocker configured to move from a retracted position to an extended position to hold the cover in the blocked position; wherein the blocker is configured to move from the extended position to the retracted position in response to applied force to allow the cover to move from the blocked position toward the open position.

15. The component of claim 14 comprising an arm configured to move relative to the blocker in response to an applied force exceeding a predetermined amount to allow the blocker to move from the retracted position to the extended position.

16. A component for a vehicle interior configured for use in a vehicle subjected in operation to at least one external force such as an applied force comprising:
a base comprising a bin;
a cover configured to move from (a) a latched position to cover the bin to (b) an open position to uncover the bin; and
a mechanism configured to move to an extended position to prevent the cover from moving toward the open position in response to an inertial force exceeding a predetermined amount;
wherein the mechanism comprises (a) a keeper configured to retain the cover in a blocked position; and (b) an arm configured to actuate the keeper when the inertial force exceeds the predetermined amount.

17. The component of claim 16 wherein the keeper comprises a blocker and the blocked position comprises the closed position.

18. The component of claim 16 wherein the keeper is configured to move from a retracted position to a deployed position in which the door is retained in the blocked position.

19. The component of claim 16 wherein the arm comprises a mass and is configured to actuate the keeper when the applied force is greater than the predetermined value.

20. The component of claim 16 wherein the arm is configured to be retained by a spring in a position to prevent the keeper from retaining the door in the blocked position; wherein the arm is configured to move to a position so that the keeper can be deployed to the blocked position when the applied force is greater than the predetermined value; wherein the keeper is configured to move under actuation from the spring to block movement of the door when the applied force is greater than the predetermined value.
